(19) United States
(12) Patent Application Publication
(10) Pub. No.: US 2015/0283620 A1
(43) Pub. Date: Oct. 8, 2015

(54) Drill Press with Pivotable Table

(71) Applicant: Lee-Cheng Chang, Taichung City (TW)

(72) Inventor: Lee-Cheng Chang, Taichung City (TW)

(21) Appl. No.: 14/242,913

(22) Filed: Apr. 2, 2014

(51) Int. Cl. B23B 39/00; B23Q 17/22; B23B 47/00

(52) U.S. Cl. CPC B23B 39/00; B23B 47/00; B23Q 17/22

(57) ABSTRACT

A drill press with pivot table(s) includes a support column and a collar disposed on an outer periphery of the support column. The outer periphery of the support column and the collar delimit a first groove therebetween. A base connects to the support column. The outer periphery of the support column and the base delimit a second groove therebetween. A pivotal device is movable relative to the support column. The pivotal device has various fixed pivoting and sliding positions relative to the support column. A first work platform connects to the pivotal device. The first work platform is movable relative to the pivotal device. A second work platform connects to the pivotal device. The second work platform is movable relative to the pivotal device.

### BACKGROUND OF THE INVENTION

1. Field of the Invention

The present invention relates to a drill press and, particularly to a drill press with pivotal table(s).

2. Description of the Related Art

Generally, a machine tool is a kind of machinery for cutting workpieces or processing machine parts. When processing a workpiece, the cutting machine includes a tooling equipped thereto moving relative to the workpiece, with a first relative movement being classified as a main movement, with a second relative movement being classified as a feed movement. A user can use the machine tool to form, cut, or connect. Different machine tools include lathes, milling machines, grinding machines, and drilling machines.

A conventional drill press is a machine tool which includes a drill head for drilling a hole on a workpiece. The drill head is set to turn, and this is a main movement of the drill head. The drill head can be axially fed. The drill press has a simple structure. However, it is not a high precision machine tool. A user can use the drill press to drill a through hole and a blind hole. With specific toolings, the user can do hole-machining operations, such as counterboring, reaming, and tapping. When the drill press is working on a workpiece, the workpiece is fixed, the drill head is moved relative to the workpiece, the center of the drill head is aligned to the center of a hole to be machined, the drill head is set to turn which is a main movement, and the drill head is axially fed.

U.S. Pat. No. 7,369,916 shows a drill press including a bench column, a head assembly and a work table. The head assembly is disposed on an end of the bench column and can drive a drill head to process a workpiece. The work table is disposed and slidable on the bench column. A workpiece to be machined is fixed on the work table. The patent teaches the work table designed for holding metal workpiece. In other words, the drill press is designed for processing metals only. So in this regard a workpieces made of different material, such as wood, a user would have to use a drill press that includes a work table suitable for fixing the wood workpiece that is machined. Therefore, drill presses with work tables assigned for fixing workpieces of different material are needed.

The present invention is, therefore, intended to obviate or at least alleviate the problems encountered in the prior art.

### SUMMARY OF THE INVENTION

According to the present invention, a drill press with pivotal table(s) includes a support column and a collar disposed on an outer periphery of the support column. The outer periphery of the support column and the collar delimit a first groove therebetween. A base defines a fixing end connecting to an end of the support column. The outer periphery of the support column and the base delimit a second groove therebetween. A head connects to another end of the support column and includes a drive device with a chuck. The drive device is in a spin motion in the operation of the head. A pivotal device connects to and is movable relative to the support column. The pivotal device has various fixed pivoting and sliding positions relative to the support column. The pivotal device includes a joint and is connected to the support column by the joint. The joint restrains and includes a positioning member releasably engaging with a track. The track includes a first end engaging in the first groove and a second end engaging in the second groove respectively. The pivotal device in a pivotal motion includes the joint pivoting about the support column and the track pivoting with the joint. The pivotal device in a slidable motion includes the joint sliding along the support column and the positioning member moving on the track. The pivotal device at a fixed height on the support column includes the positioning member engaging with the track. A first work platform connects to the pivotal device and moves relative to the support column when the pivotal device moves relative to the support column. The first work platform is movable relative to the pivotal device. A second work platform connects to the pivotal device and moves relative to the support column when the pivotal device moves relative to the support column. The second work platform is movable relative to the pivotal device.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a drill press with pivot table.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a drill press with pivotal table(s) in accordance with the present invention.

FIG. 2 is a partial, exploded perspective view of FIG. 1.

FIG. 3 is a cross-sectional view taken along line 3-3 of FIG. 1.

FIG. 3A is a partial, enlarged view of FIG. 3.

FIG. 3B is another partial, enlarged view of FIG. 3.

FIG. 4 is a cross-sectional view of FIG. 1.

FIG. 5 is an extended cross-sectional view of FIG. 4 showing a pivotal device of the drill press in different orientation than that of FIG. 4.

FIG. 6 is an extended perspective view of FIG. 1 showing the positions of the first and second tables of the drill press interchanged.

FIG. 7 is a cross-sectional view of FIG. 1 showing a drill head of the drill press in alignment with the first table.

FIG. 8 is a cross-sectional view similar to FIG. 7 but shows the first table in a different pivoting position with respect to the pivotal device than that of FIG. 7.

FIG. 9 is a cross-sectional view of FIG. 1 showing the second table pivotal with respect to the pivotal device.

### DETAILED DESCRIPTION OF THE INVENTION

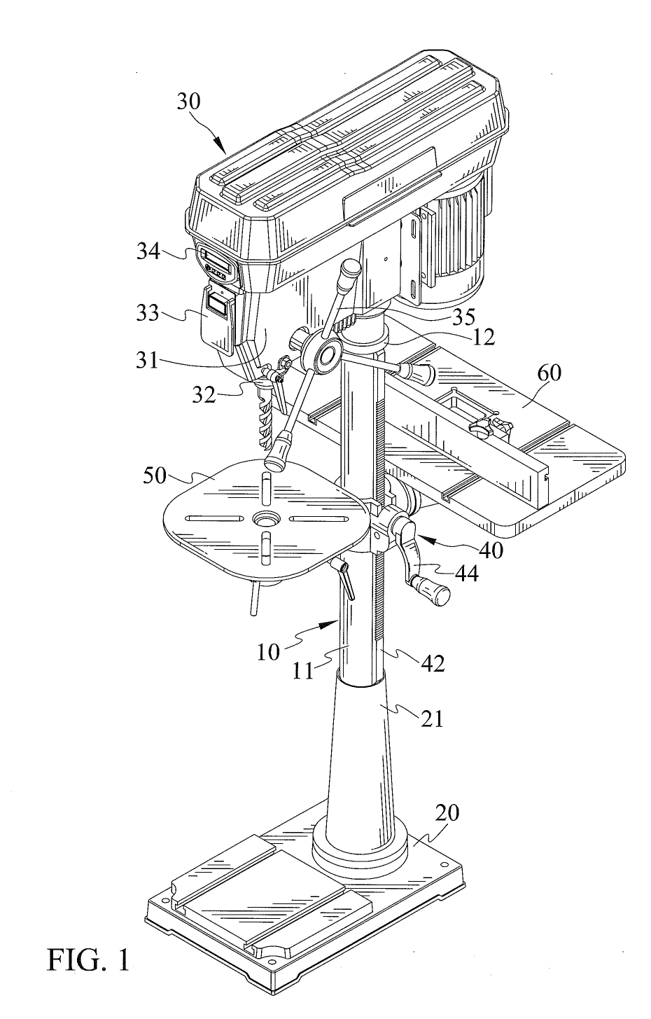

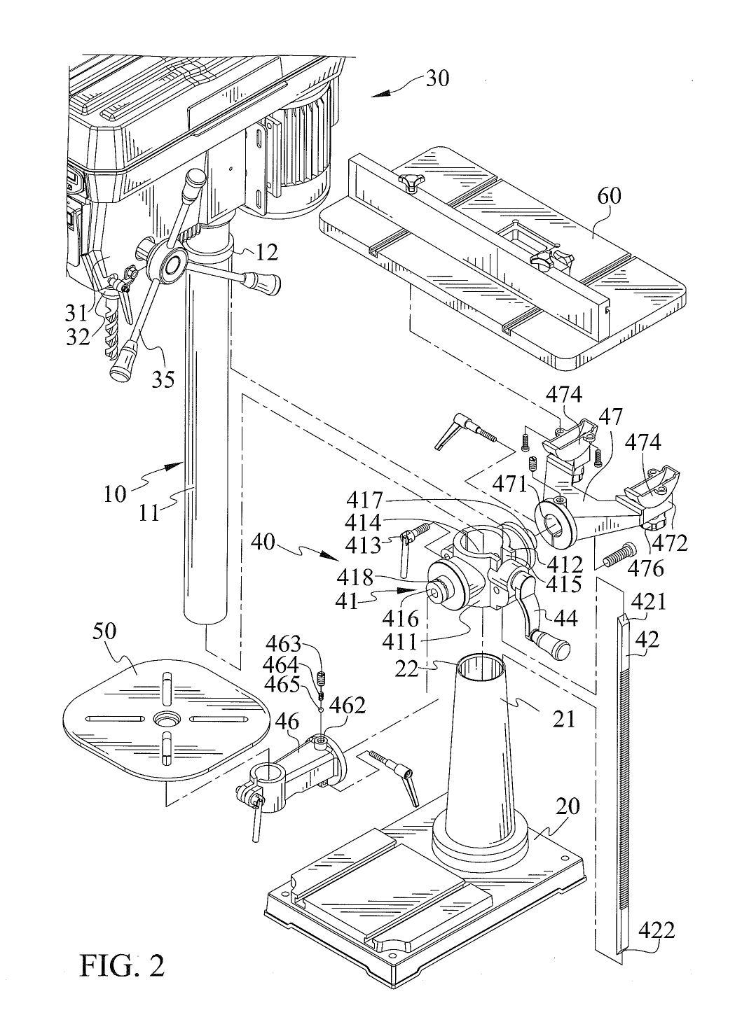

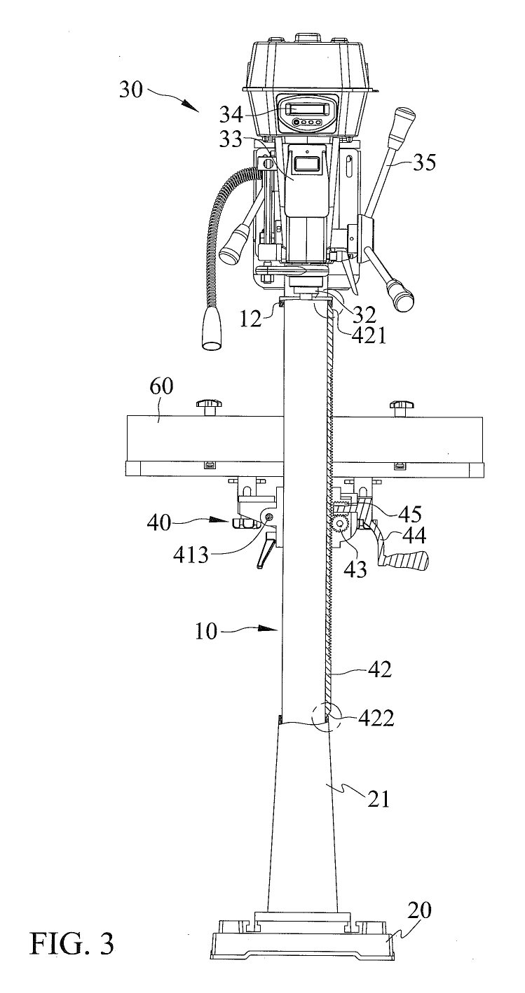

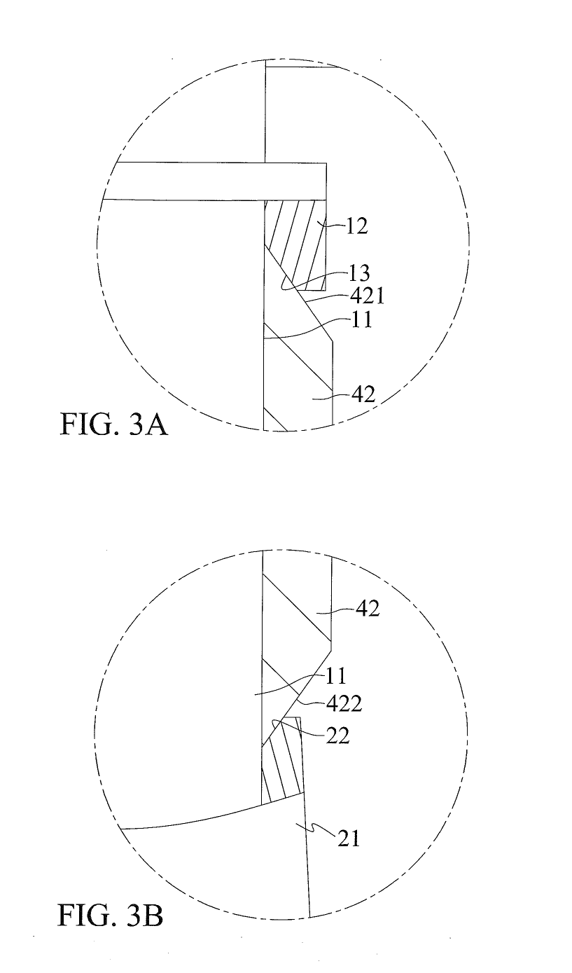

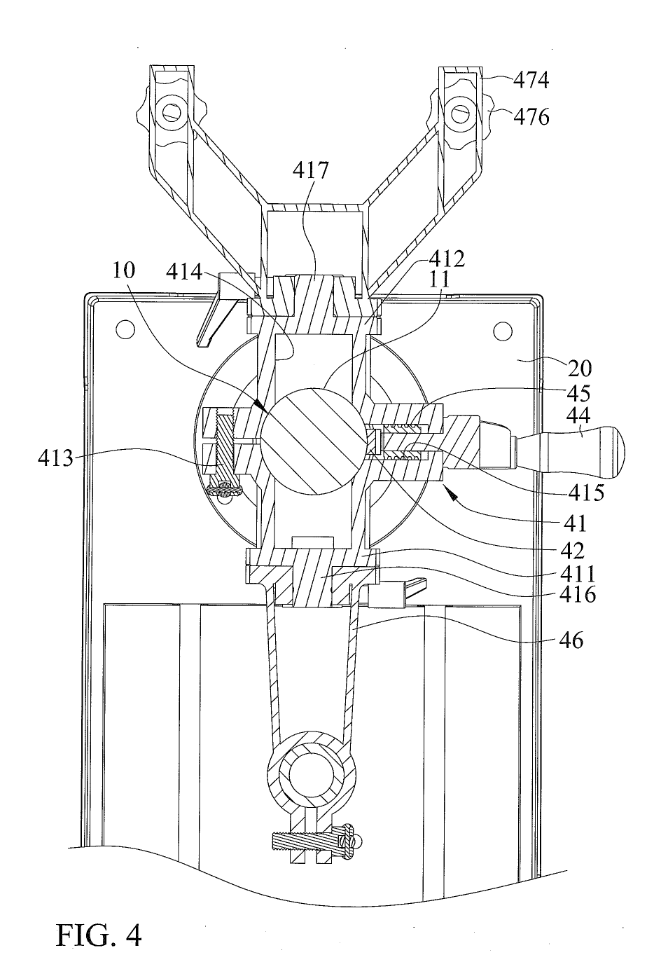

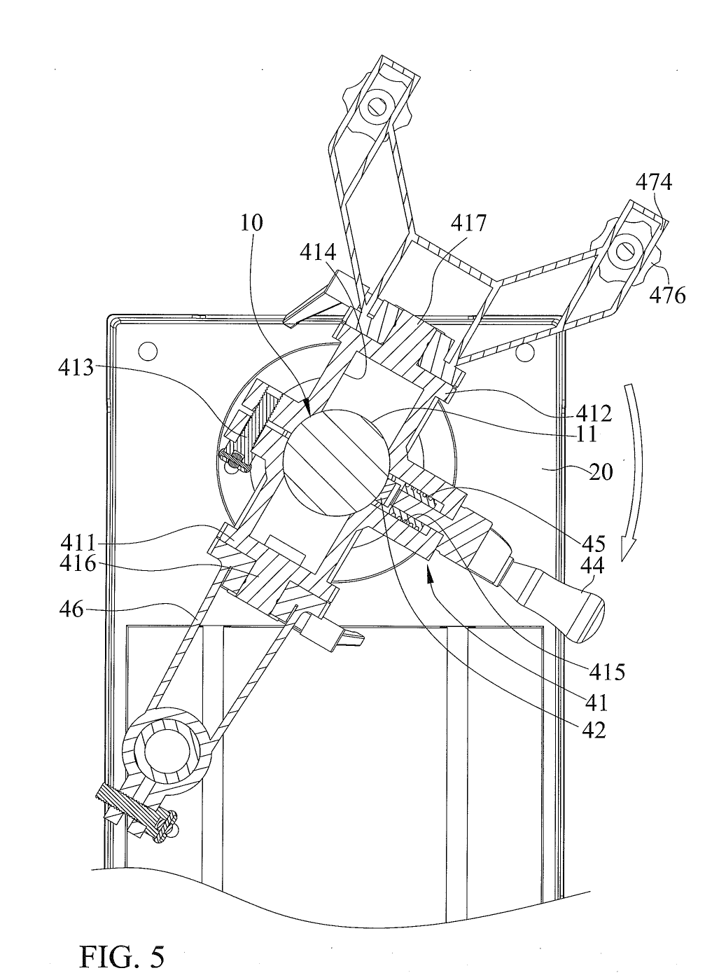

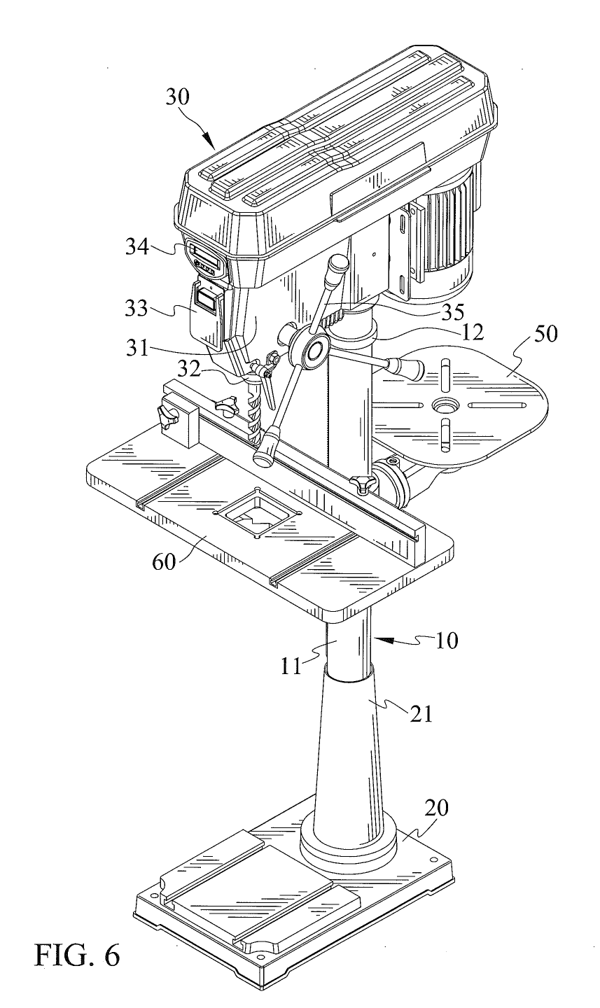

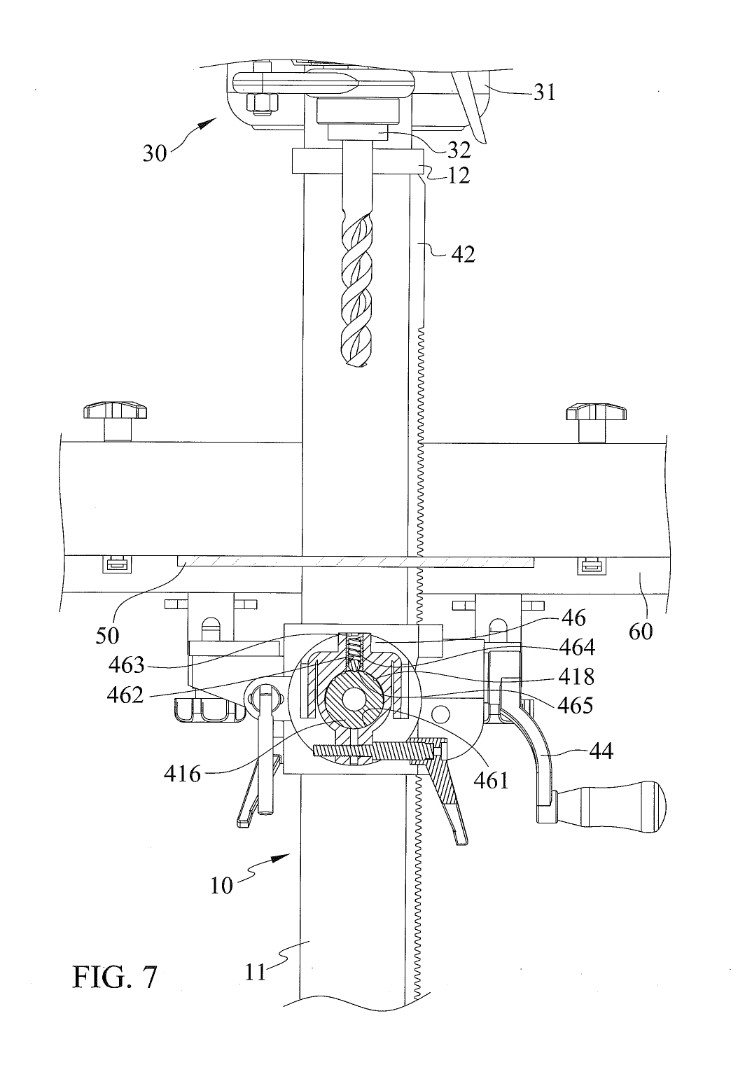

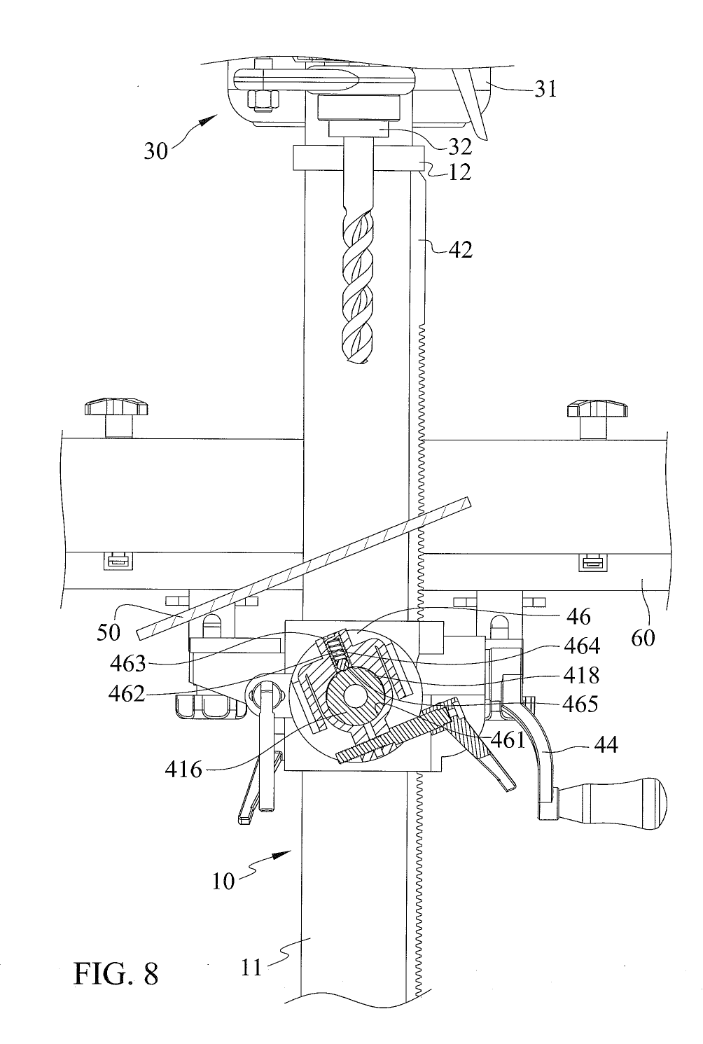

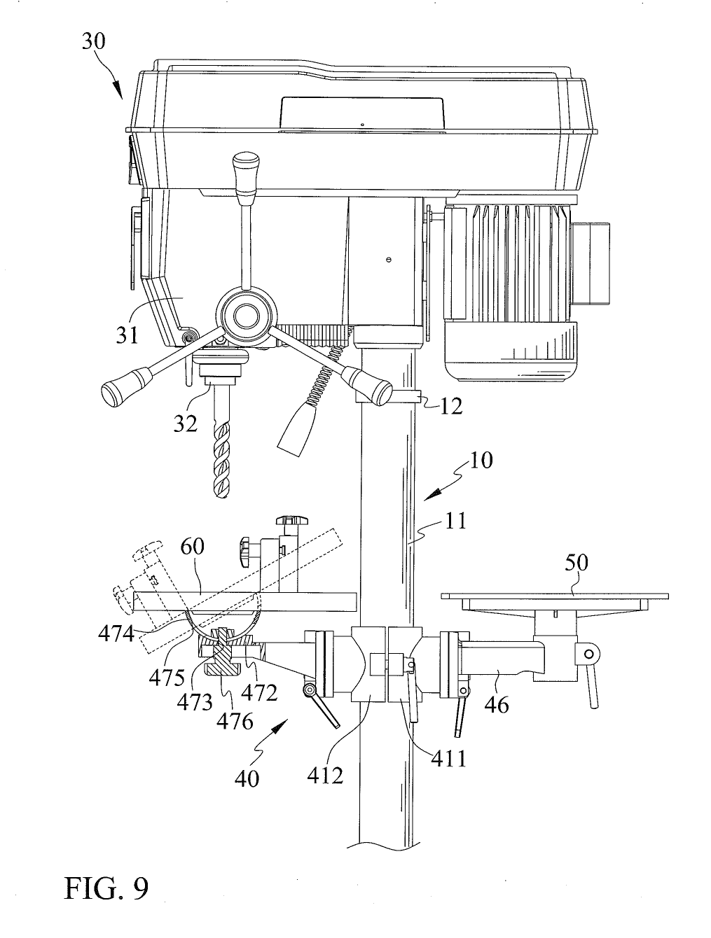

FIGS. 1 through 9 show a drill press with pivot table(s) in accordance with the present invention. The drill press includes a support column 10 and a collar 12 disposed on an outer periphery 11 of the support column 10. The outer periphery 11 of the support column 10 and the collar 12 delimit a first groove 13 therebetween;

A base 20 defines a fixing end 21 connecting to an end of the support column 10. The outer periphery 11 of the support column 10 and the base 20 delimi a second groove 22 therebetween.

A head 30 connects to another end of the support column 10 and includes a drive device 31 with a chuck 32. The drive device 31 is in a spin motion in the operation of the head 30.

The drill press has a turned on mode and a turned off mode. The drill press includes a switch 33 controlling the head 30. The drive device 31 includes a motor cooperating therewith. The switch 33 is connected with the motor. The motor can drive the drive device 31 to spin a tooling. The chuck 32 is rotated as the drive device 31 spins. The chuck 32 holds and centers the tooling. The chuck 32 and the tooling rotate about an axis. The drill press in the turned on mode thereof includes the motor transmitting mechanical energy to the drive device 31. The drill press in the turned off mode thereof includes the motor stopped.

The drive device 31 has an original position and is operably moved from the original position in the process of a workpiece. A feed handle 35 is connected to the drive device 31. A user can use the feed handle 35 to operatively move the drive device 31. An indicating system 34 is connected to the drive device 31. The indicating system 34 can detect and display a displacement of the drive device 31.

A pivotal device 40 connects to and is movable relative to the support column 10. The pivotal device 40 includes a joint 41 and is connected to the support column 10 by the joint 41. The joint 41 includes a first member 411, a second member 412, a connector 413, a first hole 414, a second hole 415. The first and second members 411 and 412 engage with each other and delimit the first and second holes 414 and 415 in between. The connector 413 inserts through an end of the first member 411 and a corresponding end of the second member 412. The joint 41 restrains and includes a positioning member 43 releasably engaging with a track 42. The support column 10 inserts through the first hole 414. The track 42 inserts through the second hole 415. The positioning member 43 is disposed in the second hole 415. The first and second holes 414 and 415 connect together. The support column 10 includes the outer periphery 11 thereof abutting against an inner periphery of the first hole 414. The first and second members 411 and 412 thus stably engage with the column 10. The track 42 includes a first end 421 engaging in the first groove 13 and a second end 422 engaging in the second groove 22 respectively. The first end 421 of the track 42 and the first groove 13 include a surface contract, with the first end 421 of the track 42 having a first sloped surface and the first groove 13 having a second sloped surface abutting against the first slopped surface. The second end 422 of the track 42 and the second groove 22 include a surface contact, with the second end 422 of the track 42 having a third sloped surface and the second groove 22 having a fourth sloped surface abutting against the third slopped surface. The track 42 is configured to include first array of a plurality of teeth arranged linearly and the positioning member 43 is configured to include a second array of a plurality of teeth arranged annularly respectively.

The pivotal device 40 has various fixed pivoting and sliding positions relative to the support column 10. The pivotal device 40 in a pivotal motion includes the joint 41 pivoting about the support column 10 and the track 42 pivoting with the joint 41. The pivotal device 40 includes a first pivotal extension 46 connecting to the first work platform 50, with the first pivotal extension 46 fixing to the joint 41 and pivotal about a first axis, and with the first work platform 50 having the fixed pivoting positions about the first axis. The first pivotal extension 46 delimits a first recess 461 and the joint 41 defines a first joining end 416 engaging in the first recess 461. The first pivotal extension 46 is pivotal about the first joining end 416. The first work platform 50 in one of the fixed pivoting positions relative to the pivotal device 40 includes the first pivotal extension 46 unmoved relative to the first joining end 416, with the first joining end 416 including a plurality of first positioning slots 418 and the first pivotal extension 46 including a positioning device retained on one of the plurality of first positioning slots 418. The positioning device includes a cap 463, a biasing member 464, and a detent member 465. The positioning device is received in an aperture 462 extending in the first pivotal extension 46. The aperture 462 is connected to the first recess 461. The detent member 465 engages with the first joining end 416. The biasing member 464 includes an end abutting against the detent member 465 and another end abutting against the cap 463. The cap 463 restrains the biasing and detent member 464 and 465. The detent member 465 is in the shape of a sphere. The first positioning slots 418 are arranged in an array and spaced one after another. The first positioning slots 418 are equally spaced one after another. The array of the first positioning slots 418 are arranged annularly. The pivotal device 40 includes a second pivotal extension 47 connecting to the second work platform 60, with the second pivotal extension 47 fixing to the joint 41 and pivotal about a second axis, and with the second work platform 60 having the fixed pivoting positions about the second axis. The first and second axes are parallel to each other. The second pivotal extension 47 delimits a second recess 471 and the joint 41 defines a second joining end 417 engaging in the second recess 471. The second pivotal extension 47 is pivotal about the second joining end 417. The second work platform 60 in one of the fixed pivoting positions relative to the pivotal device 40 includes the second pivotal extension 47 unmoved relative to the second joining end 417. The second pivotal extension 47 defines at least one connecting end 472. In the embodiment, the second pivotal extension defines two bifurcating connecting ends 472. The at least one connecting end 472 includes at least one holder 474 holding the second work platform 60. The at least one holder 474 is pivotally disposed on the at least one connecting end 472. The at least one holder 474 has a curved outer periphery. The at least one holder 474 has two distal ends and extends curvedly between the two distal ends. The at least one connecting end 472 includes at least one orifice 473. The at least one orifice 473 extends between the two distal ends of the at least one holder 474 and has a curved cross section. The at least one holder 474 includes at least one second positioning slot 475. The at least one holder 474 includes at least one adjustor 476 engaging therewith. The at least one adjustor 476 restrains the holder 474 in the fixed pivoting positions. The adjustor 476 engages in the at least one orifice 473 and the at least one second positioning slot 475. The first pivotal extension 46 is disposed on the first member 411. The second pivotal extension 47 is disposed on the second member 412. The pivotal device 40 in a slidable motion includes the joint 41 sliding along the support column 10 and the positioning member 43 moving on the track 42. The pivotal device 40 at a fixed height on the support column 10 includes the positioning member 43 engaging with the track 42. The pivotal device 40 in the slidable motion includes the positioning member 43 rolling on the track 42 and the second array of the plurality of teeth engaging with the first array of the plurality of teeth.

The pivotal device 40 has a controlled sliding movement. The pivotal device 40 includes an input. The input includes a handle 44 including a third array of a plurality of teeth 45 engaging with the second array of the plurality of teeth. The second hole 415 receives the third array of the plurality of teeth. The handle 44 extends and is disposed outside the joint 41. The handle 44 is rotated during the operation therof.

A first work platform 50 connects to the pivotal device 40 and moves relative to the support column 10 when the pivotal device 40 moves relative to the support column 10. The first work platform 50 is movable relative to the pivotal device 40.

A second work platform 60 connects to the pivotal device 40 and moves relative to the support column 10 when the pivotal device 40 moves relative to the support column 10. The second work platform 60 is movable relative to the pivotal device 40.

The first and second work platforms 50 and 60 have various fixed pivoting positions with respect to the pivotal device 40.

The first and second work platforms 50 and 60 are made of different material. One of the first and second work platforms 50 and 60 is made of metal and the other is made of wood.

In view of the forgoing, the pivotal device 40 has various fixed pivoting and sliding positions relative to the support column 10. The pivotal device 40 is connected to the support column 10 by the joint 41. The joint 41 restrains and includes the positioning member 43 releasably engaging with the track 42. The track 42 includes the first end engaging in the first groove 13 and the second end engaging in the second groove 22 respectively. The pivotal device 40 in the pivotal motion includes the joint 41 pivoting about the support column 10 and the track 42 pivoting with the joint 41. The pivotal device 40 in a slidable motion includes the joint 41 sliding along the support column 10 and the positioning member 43 moving on the track 42. The pivotal device 40 at a fixed height on the support column 10 includes the positioning member 43 engaging with the track 42. The first work platform 50 connects to the pivotal device 40 and moves relative to the support column 10 when the pivotal device 40 moves relative to the support column 10. The first work platform 50 is movable relative to the pivotal device 40. The second work platform 60 connects to the pivotal device 40 and moves relative to the support column 10 when the pivotal device 40 moves relative to the support column 10. The second work platform 60 is movable relative to the pivotal device 40.

The foregoing is merely illustrative of the principles of this invention and various modifications can be made by those skilled in the art without departing from the scope and spirit of the invention.

What is claimed is:

1. A drill press with pivot table(s) comprising:
a support column and a collar disposed on an outer periphery of the support column, with the outer periphery of the support column and the collar delimiting a first groove therebetween;
a base defining a fixing end connecting to an end of the support column, with the outer periphery of the support column and the base delimiting a second groove therebetween;
a head connecting to another end of the support column and including a drive device with a chuck, with the drive device in a spin motion in the operation of the head;
a pivotal device connecting to and movable relative to the support column, with the pivotal device having various fixed pivoting and sliding positions relative to the support column, and wherein the pivotal device includes a joint and is connected to the support column by the joint, wherein the joint restrains and includes a positioning member releasably engaging with a track, wherein the track includes a first end engaging in the first groove and a second end engaging in the second groove respectively, wherein the pivotal device in a pivotal motion includes the joint pivoting about the support column and the track pivoting with the joint, wherein the pivotal device in a slidable motion includes the joint sliding along the support column and the positioning member moving on the track, and wherein the pivotal device at a fixed height on the support column includes the positioning member engaging with the track;
a first work platform connecting to the pivotal device and moving relative to the support column when the pivotal device moves relative to the support column, and wherein the first work platform is movable relative to the pivotal device; and
a second work platform connecting to the pivotal device and moving relative to the support column when the pivotal device moves relative to the support column, and wherein the second work platform is movable relative to the pivotal device.

2. The drill press as claimed in claim 1, wherein the first and second work platforms have various fixed pivoting positions with respect to the pivotal device.

3. The drill press as claimed in claim 1, wherein the first and second work platforms are made of different material.

4. The drill press as claimed in claim 3, wherein one of the first and second work platforms is made of metal and the other is made of wood.

5. The drill press as claimed in claim 1, wherein the first end of the track and the first groove include a surface contract, with the first end of the track having a first sloped surface and the first groove having a second sloped surface abutting against the first slopped surface, wherein the second end of the track and the second groove include a surface contact, with the second end of the track having a third sloped surface and the second groove having a fourth sloped surface abutting against the third slopped surface.

6. The drill press as claimed in claim 1, wherein the joint includes a first member, a second member, a connector, a first hole, and a second hole, with the first and second members engaging with each other and delimiting the first and second holes in between, with the connector inserting through an end of the first member and a corresponding end of the second member, wherein the support column inserts through the first hole, wherein the track inserts through the second hole, and wherein the positioning member is disposed in the second hole.

7. The drill press as claimed in claim 1, wherein the track is configured to include first array of a plurality of teeth arranged linearly and the positioning member is configured to include a second array of a plurality of teeth arranged annularly respectively, wherein the pivotal device in the slidable motion includes the positioning member rolling on the track and the second array of the plurality of teeth engaging with the first array of the plurality of teeth.

8. The drill press as claimed in claim 7, wherein the pivotal device has a controlled sliding movement, with the pivotal device includes an input, with the input including a handle including a third array of a plurality of teeth engaging with the second array of the plurality of teeth, with the second hole receiving the third array of the plurality of teeth.

9. The drill press as claimed in claim 1, wherein the pivotal device includes a first pivotal extension connecting to the first work platform, with the first pivotal extension fixing to the joint and pivotal about a first axis, and with the first work platform having the fixed pivoting positions about the first axis, and wherein the pivotal device includes a second pivotal extension connecting to the second work platform, with the second pivotal extension fixing to the joint and pivotal about a second axis, and with the second work platform having the fixed pivoting positions about the second axis.

10. The drill press as claimed in claim 9, wherein the first and second axes are parallel to each other.

11. The drill press as claimed in claim 9, wherein the first pivotal extension delimits a first recess and the joint defines a first joining end engaging in the first recess, wherein the first pivotal extension is pivotal about the first joining end, and wherein the first work platform in one of the fixed pivoting positions relative to the pivotal device includes the first pivotal extension unmoved relative to the first joining end, with the first joining end including a plurality of first positioning slots and the first pivotal extension including a positioning device retained on one of the plurality of first positioning slots.

12. The drill press as claimed in claim 11, wherein the positioning device includes a cap, a biasing member, and a detent member, with the positioning device received in an aperture extending in the first pivotal extension, with the aperture connected to the first recess, with the detent member engaging with the first joining end, with the biasing member including an end abutting against the detent member and another end abutting against the cap, and with the cap restraining the biasing and detent member.

13. The drill press as claimed in claim 11, wherein the second pivotal extension delimits a second recess and the joint defines a second joining end engaging in the second recess, wherein the second pivotal extension is pivotal about the second joining end, and wherein the second work platform in one of the fixed pivoting positions relative to the pivotal device includes the second pivotal extension unmoved relative to the second joining end.

14. The drill press as claimed in claim 11, wherein the second pivotal extension defines at least one connecting end, with the at least one connecting end including at least one holder holding the second work platform, wherein the at least one holder is pivotally disposed on the at least one connecting end, with the at least one connecting end including at least one orifice, with the at least one holder including at least one second positioning slot, with the at least one holder including at least one adjustor engaging therewith, with the at least one adjustor restraining the holder in the fixed pivoting positions, and with the adjustor engaging in the at least one orifice and the at least one second positioning slot.

15. The drill press as claimed in claim 14, wherein the at least one holder has a curved outer periphery, with the at least one holder having two distal ends and extending curvedly between the two distal ends.

16. The drill press as claimed in claim 1, wherein the drive device includes an indicating system connected thereto, with the indicating system detecting and displaying a displacement of the drive device.
